(19) United States
(12) Patent Application Publication
(10) Pub. No.: US 2020/0193005 A1
(43) Pub. Date: Jun. 18, 2020

(54) AUTHENTICATION SYSTEM FOR VEHICLE

(71) Applicant: ZF ACTIVE SAFETY AND ELECTRONICS US LLC, Livonia, MI (US)

(72) Inventors: MICHAEL L. BABALA, Plymouth, MI (US); RALPH R. REINHOLD, Farmington Hills, MI (US)

(21) Appl. No.: 16/714,894

(22) Filed: Dec. 16, 2019

Related U.S. Application Data
(60) Provisional application No. 62/780,369, filed on Dec. 17, 2018.

(51) Int. Cl. G06F 21/32; G06K 9/00; G07C 9/00

(52) U.S. Cl. CPC G06F 21/32; G06K 9/00248; G07C 2009/00507; G07C 9/00309; G06K 9/00348

(57) ABSTRACT

A method of unlocking a vehicle includes acquiring images of a person approaching the vehicle. A gait and facial features of the person are determined based on the acquired images. The determined gait is matched to a stored gait in a first data set. The determined facial features are matched to stored facial features in a second data set. The vehicle is unlocked if the matched gaits and matched facial features indicate the person is an authorized person.

### RELATED APPLICATIONS

This application claims the benefit of U.S. Provisional Application Ser. No. 62/780,369, filed Dec. 17, 2018, the entirety of which is incorporated by reference herein.

### TECHNICAL FIELD

The present invention relates generally to vehicle security, and specifically to a vision system for selectively unlocking a vehicle.

### SUMMARY

In one example, a method of unlocking a vehicle includes acquiring images of a person approaching the vehicle. A gait and facial features of the person are determined based on the acquired images. The determined gait is matched to a stored gait in a first data set. The determined facial features are matched to stored facial features in a second data set. The vehicle is unlocked if the matched gaits and matched facial features indicate the person is an authorized person.

In another example, a method of unlocking a vehicle includes acquiring images of a person approaching the vehicle. A gait and facial features of the person are determined based on the acquired images. The determined gait is matched to a stored gait in a first data set with a first probability exceeding a predetermined value. The determined facial features are matched to stored facial features in a second data set with a second probability. The vehicle is unlocked if the first and second probabilities collectively indicate the person is an authorized person.

In another example, a method of unlocking a vehicle includes acquiring images of a person approaching the vehicle and sensing motion of the person. A gait of the person is determined based on the acquired images and sensed motion when the person reaches a first predetermined distance from the vehicle. Facial features of the person are determined based on the acquired images when the person reaches a second predetermined distance from the vehicle closer than the first predetermined distance. The determined gait is matched to a stored gait in a first data set with a first probability. The determined facial features are matched to stored facial features in a second data set with a second probability. The vehicle is unlocked if the first and second probabilities collectively indicate the person is an authorized person

Other objects and advantages and a fuller understanding of the invention will be had from the following detailed description and the accompanying drawings.

### BRIEF DESCRIPTION OF THE DRAWINGS

FIG. 1 is a top view of a vehicle including an example vision system.

FIG. 2 is a front view of the vehicle of FIG. 1.

FIG. 3 is a schematic illustration of the vision system.

FIG. 4 is a flow chart illustrating an example method of identifying a person approaching the vehicle.

### DETAILED DESCRIPTION

The present invention relates generally to vehicle security, and specifically to a vision system for selectively unlocking a vehicle for a person/driver based on their gait and facial recognition. Gait patterns for a person can vary depending on differences in speed of approach, e.g., walking, jogging, running, etc., variations in footwear, e.g., running shoes vs. heels, and/or if the person is using mobility assist devices, e.g., a walker or crutches.

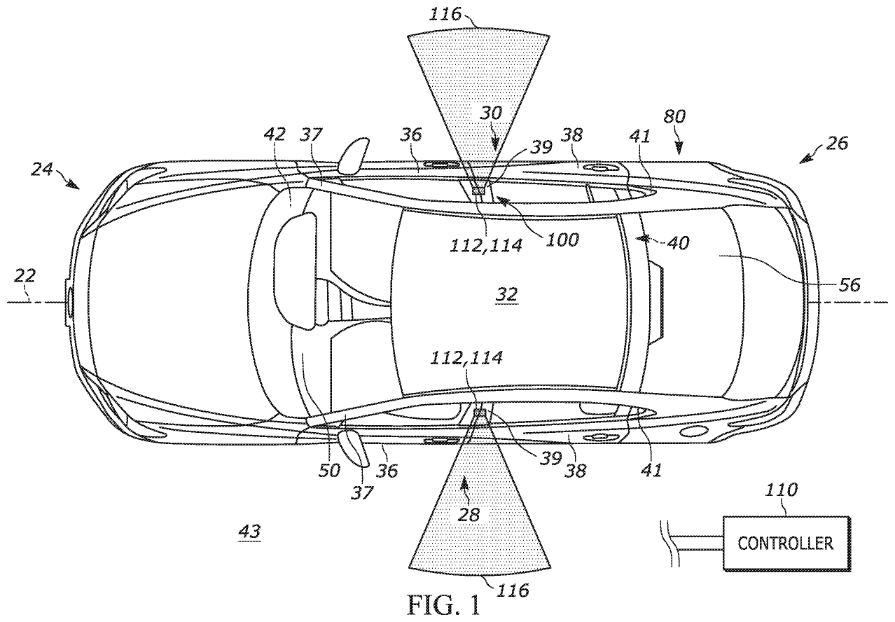

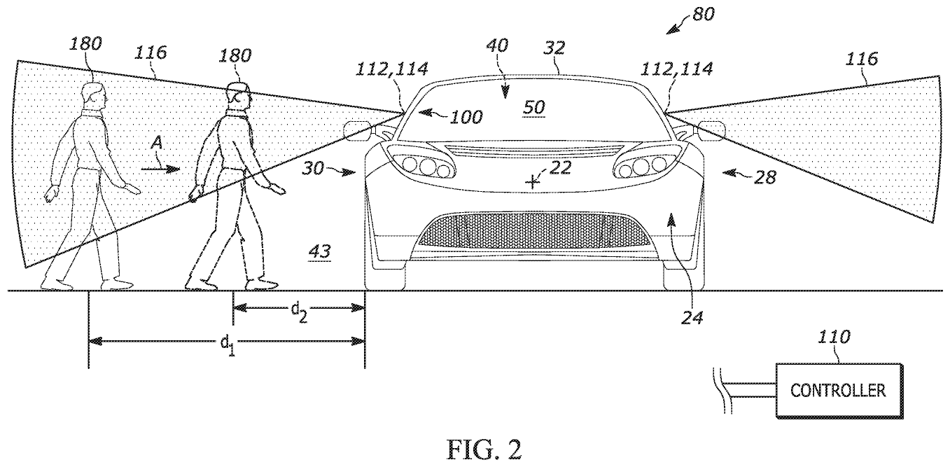

FIGS. 1-2 illustrate a vehicle 80 having an example vision system 100 for acquiring and processing images outside the vehicle. The vehicle 80 extends along a centerline 22 from a first or front end 24 to a second or rear end 26. The vehicle 80 extends to a left side 28 and a right side 30 on opposite sides of the centerline 22.

Each side 28, 30 of the vehicle 80 includes a A-pillar 37, B-pillar 39, and C-pillar 41. Front and rear doors 36, 38 are provided on both sides 28, 30 and connected to the doors 36, 38. The vehicle 80 includes a roof 32 that cooperates with the front and rear doors 36, 38 and pillars 37, 39, 41 on each side 28, 30 to define a passenger cabin or interior 40. The exterior of the vehicle 80 is indicated at 43.

The front end 24 of the vehicle 80 includes an instrument panel 42 facing the interior 40. A windshield or windscreen 50 is located between the instrument panel 42 and the roof 32. A rear window 56 at the rear end 26 of the vehicle 80 helps close the interior 40.

The vision system 100 includes at least one outward facing camera 112 positioned on the vehicle 80 for acquiring images of the exterior 41. As shown, cameras 112 are connected to each B-pillar 39, although other locations, e.g., the A-pillar 37, C-pillar 41 or roof 32, are contemplated. In any case, each camera 112 has a field of view 116 extending outward from the respective side 28, 30. Although both cameras 112 operate in the same manner only operation of the camera connected to the right side 30 is described for brevity.

The camera 112 produces signals indicative of the images taken within the field of view 116 on the right side 30 of the vehicle 80 and sends the signals to a controller 110. The controller 110, in turn, processes the signals for future use. A motion sensor 114 can be connected to the controller 110 and have the same field of view 116 as the camera 112 for detecting motion within the field of view. That said, the motion sensor 114 can face outward to the exterior 43 and be connected to the B-pillar 39. The motion sensor 114 sends signals indicative of the detected motion to the controller 110. The camera 112 and motion sensor 114 can cooperate to detect a person 180 approaching the vehicle 80 in the manner indicated by the arrow A in FIG. 2. To this end, the camera 112 and motion sensor 114 can operate in a wake-up mode utilizing minimal power and start capturing data when either detects a person 180 in the field of view 116.

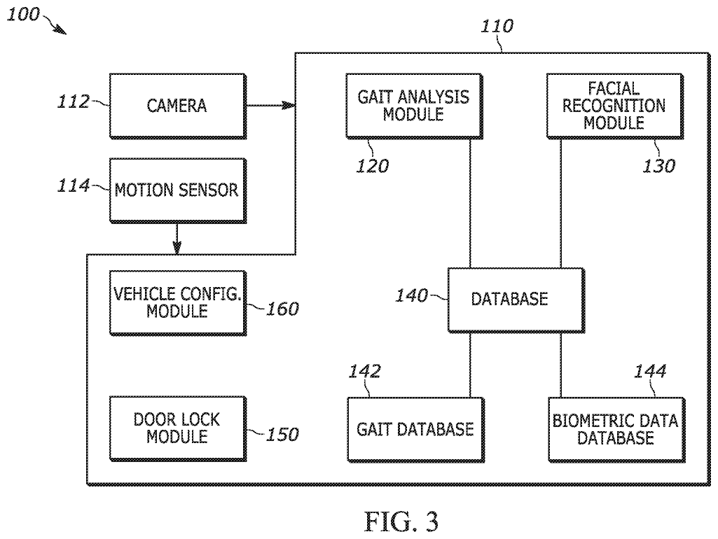

As shown in FIG. 3, the controller 100 includes a gait analysis module 120 and facial recognition module 130 for helping identify the person 180. Both modules 120, 130 communicate with a database or data set 140. The database 140 includes stored identities of persons authorized to access and operate the vehicle 80. In one example, the database 140 includes a database or data set 142 of stored gaits associated with the stored identities. A database or data set 144 of stored biometric data, e.g., faces, facial features, fingerprints, voice or retinal data, is also associated with the stored identities and corresponds with the database 142 of gaits. In other words, each authorized person of the vehicle 80 has a stored identity in the database 140, which corresponds with one or more stored gaits in the database 142 and stored biometric data in the database 144.

The controller 110 further includes a door lock module 150 for selectively locking and unlocking the doors 36, 38. A vehicle configuration module 160 includes stored vehicle 80 settings and preferences including steering column preferences, stereo preferences, driver seat position preferences, and climate control preferences.

The gait analysis module 120 is configured to analyze the signals from the camera 112 and calculate/detect the gait of the person 180. The controller 100 then compares the detected gait to the database 142 to see if a match exists. The gait analysis is done when the person 180 is at a first predetermined distance d₁ from the vehicle 80 (see FIG. 2).

That said, the accuracy of a detected gait match can vary. More specifically, the gait analysis module 120 analyses the detected gait and derives a first probability P₁ that the detected gait is accurately matched with a gait stored in the database 142. When a detected gait is close (or identical to) a stored gait in the database 142, the gait analysis module 120 derives a relatively higher first probability P₁. On the other hand, when the detected gait is significantly different from a stored gait, the gait analysis module 120 derives a relatively lower first probability P₁. Consequently, the first probability P₁ decreases as the differences between a detected gait pattern and a stored gait pattern increase.

When the person 180 reaches a second predetermined distance d₂ (see FIG. 3) from the vehicle 80 closer than the first predetermined distance d₁, the facial recognition module 130 analyzes the signals from the camera 112 and identifies the facial features of the person 180. The controller 110 then compares the identified facial features to the facial features stored in the database 144 to see if a match exists.

The accuracy of the facial recognition match can vary. During facial recognition analysis, the facial recognition module 130 derives a second probability P₂ that the identified facial features of the person 180 are accurately matched with facial features stored in the database 144. When the detected facial features are close (or identical to) stored facial features in the database 144, the facial recognition module 130 derives a relatively higher second probability P₂. On the other hand, when the identified facial features are significantly different from the stored facial features, the facial recognition module 130 derives a relatively lower second probability P₂. Consequently, the second probability P₂ decreases as the differences between identified facial features and stored facial features increase.

In one example, the first and second probabilities P₁, P₂ can be combined by the controller 110 in a manner that allows the controller to determine an overall probability or confidence Pₒ in the identification assessment of the person 180, e.g., averaged, weighted average, summed, etc. An overall probability Pₒ that is at or below a selected threshold value, e.g., 90% or above, will result in the controller 110 determining the person 180 is unauthorized to access or operate the vehicle 80.

When the overall probability Pₒ exceeds the threshold value the controller 110 determines the person 180 is authorized to access or operate the vehicle 80. In response, the controller 110 communicates with the door lock module 150 to unlock/open the vehicle doors 36, 38. The controller 110 can also instruct a vehicle configuration module 160 to adjust the settings of the vehicle 80 to match driving and/or seating preferences associated with the identified person 180.

In another example, the controller 100 only proceeds to performing facial recognition analysis if the first probability P₁ exceeds a first predetermined value, e.g., 90% or greater (a two-tiered evaluation). If the first probability P₁ is at or below the first predetermined value no facial recognition analysis is performed. That said, if the controller 100 proceeds to facial recognition analysis and the second probability P₂ exceeds a second predetermined value, e.g., 90% or greater, the controller can determine that the person 180 is an authorized person. If the second probability P₂ is at or below the second predetermined value the person 180 is deemed an unauthorized person. The first and second predetermined values can be the same or different. In both this case and the use of the overall probability Pₒ both probabilities P₁, P₂ are collectively taken into account before determining whether or not the person 180 is an authorized person.

It will be appreciated that the vision system 100 can further include additional identification devices, e.g., a microphone, voice or fingerprint scanner, for collecting additional biometric identification information from the person 180. The additional biometric information can be requested from the person 180 if one or both of the gait and facial recognition analysis is faulty or unclear. When this occurs, the controller 110 will compare the identification information collected by the additional identification devices with associated info in the database 144 and determine whether the person 180 is authorized based on a third, fourth, etc., probability associated with the additional comparisons. These additional probabilities can be combined with the first and second probabilities P₁, P₂ to generate the overall probability Pₒ. Alternatively, the additional probabilities can be added to the sequential analysis described, e.g., proceed to the next analysis only if the third, fourth, etc., probability exceeds an associated threshold.

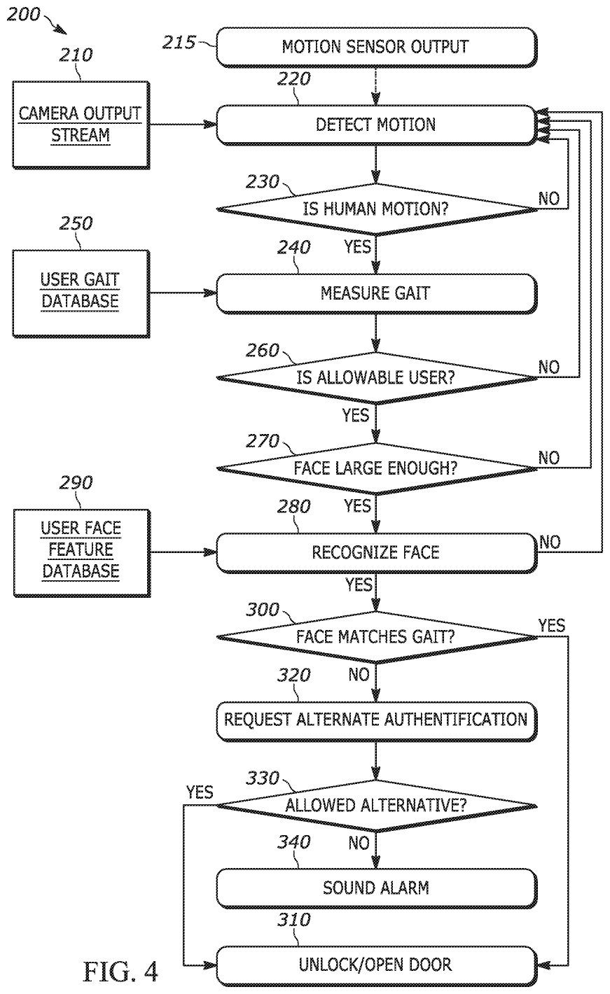

FIG. 4 illustrates a flow chart of an example method 200 for identifying a person as an authorized person of a vehicle. The method 200 will be described with respect to the components of the vision system 110 of FIG. 1 in response to a person 180 approaching the vehicle 80 or coming within a predetermined distance thereof, e.g., within the field of view 116.

In step 210, the camera 112 outputs a continuous stream of image data to the controller 110. When present, the motion sensor 114 outputs a continuous stream of data to the controller 110 at step 215. At step 220, the controller 110 analyses the image data and/or motion sensor data and detects motion in the field of view 116. At step 230, the controller 110 ascertains whether the motion in the field of view 116 is indicative of human motion—as opposed to animal, vehicle, etc. If the answer is “no”, the method returns to step 220 and the controller continues monitoring the camera image and motion sensor data streams for motion in the field of view 116. If the answer is “yes” at step 230, a person 180 has been detected and the method moves to step 240 in which the gait analysis module 120 analyses the camera image data to ascertain the gait of the person.

In performing step 240, the controller 110 accesses the gait database 142 at step 250 At step 260, the controller 110 looks for a match of the detected gait in the database 142 to determine if the determined gait corresponds with the gait of an authorized person of the vehicle 80. If the answer is “no”, the controller 110 denies access to the vehicle 80 and returns to step 220. Access can be denied by checking or actuating the door lock module 150 to ensure the vehicle doors 36, 38 are locked.

If the answer is “yes” at step 260, the controller 110 then proceeds to step 270 and determines whether the facial features or images captured in the camera images are suitable for performing facial recognition analysis. In other words, the controller 110 evaluates whether the images were taken close enough to the vehicle 80 to provide adequate image resolution for reliable facial recognition analysis. If the facial features are deemed too blurry or too small, e.g., the person 180 was too far away from the vehicle 80, the controller 110 denies access to the vehicle 80 and returns to step 220.

If the facial features are deemed sufficiently large, the controller 110 proceeds to step 280 and instructs the facial recognition module 130 to analyze the camera image data to determine the facial features of the person 180. In step 290, the controller 110 accesses the database 144 and looks for a match of the detected facial features in the biometric data database 144 to ascertain whether the determined facial features correspond with the face of an authorized person of the vehicle 80.

If the answer is “no”, the controller 110 denies access to the vehicle 80 and returns to step 220. If the answer is “yes”, the controller 110 proceeds to step 300 and analyzes whether the determined gait and facial features belong to the same authorized user of the vehicle 80 based on the stored identities in the database 140. If the answer is “yes”, the controller proceeds to step 310 and actuates the door lock module 150 to unlock the vehicle door(s) 36, 38.

If, however, the answer is “no”, the controller proceeds to step 320 and requests additional identification, e.g., voice recognition, retinal or fingerprint scan, from the person 180. The request can be made audibly and/or visually. In any case, when the person 180 provides the additional identification, the controller 110 proceeds to step 330 and determines if the additional identification provided matches any of the biometric data in the database 144. If the answer is “no”, the controller 110 sounds the alarm at step 340. If the answer is “yes”, the controller moves to step 310 and actuates the door lock module 150 to unlock the vehicle door(s).

The method 200 can also include adjusting one or more vehicle settings (not shown) to stored preferences for the person 180 once that person has been matched to an authorized person in the database 140 with a predetermined probably, e.g., above 90%. The preferences can include steering column preferences, driver seat preferences, stereo preferences, and climate control preferences. Other preferences can also be included.

It will be appreciated that any “no” and “yes” used in the method 200 can be based on one or more of the probabilities P₁, P₂, Pₒ, other algorithms, and other threshold values that dictate whether an identification/authentication is deemed reliable enough to designate the person 180 as an authorized person and one that is not.

The vision system shown and described herein is advantageous in that it provides a non-invasive, two-tier recognition scheme for identifying persons approaching or in the vicinity of the vehicle. The vision system therefore does not require the person to carry a device, e.g., key fob, to be recognized and identified. Moreover, using two-tier confirmation makes it more difficult to bypass the vision system and access the vehicle by, for example, placing a photograph of an authorized person in front of the camera or wearing a mask/makeup to distort facial features.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A method of unlocking a vehicle, comprising:
acquiring images of a person approaching the vehicle;
determining a gait and facial features of the person based on the acquired images;
matching the determined gait to a stored gait in a first data set;
matching the determined facial features to stored facial features in a second data set; and
unlocking the vehicle if the matched gaits and matched facial features indicate the person is an authorized person.

2. The method recited in claim 1, wherein the determined gait is matched to the stored gait with a first probability and the determined facial features are matched to the stored facial features with a second probability, the vehicle being unlocked if the first and second probabilities collectively indicate the person is an authorized person.

3. The method recited in claim 2, wherein the vehicle is unlocked when an average of the first and second probabilities exceeds a threshold value.

4. The method recited in claim 2, wherein the vehicle is unlocked when the first probability exceeds a first predetermined value and the second probability exceeds a second predetermined value.

5. The method recited in claim 1, wherein the step of matching the determined facial features to stored facial features is performed only when the determined gait is matched to the stored gait with a first probability exceeding a predetermined value.

6. The method recited in claim 1 further comprising accessing a third data set connected to the first and second data sets and having a list of authorized persons, each of the authorized persons having an associated stored gait and stored facial features.

7. The method recited in claim 1, wherein the gait of the person is determined when the person reaches a first predetermined distance from the vehicle.

8. The method recited in claim 7, wherein the facial features of the person are determined when the person reaches a second predetermined distance from the vehicle closer than the first predetermined distance.

9. The method recited in claim 1 further comprising configuring the vehicle to preferences of the person when the person is indicated as an authorized person.

10. The method recited in claim 1 further comprising sensing motion of the person from a motion sensor connected to the vehicle.

11. The method recited in claim 10, wherein the step of determining a gait of the person includes evaluating the images and the sensed motion.

12. The method recited in claim 1 further comprising accessing a third data set connected to the first and second data sets and having a list of authorized persons, each of the authorized persons having an associated stored gait and stored facial features.

13. The method recited in claim 1 further comprising configuring the vehicle to preferences of the person when the person is indicated as an authorized person.

14. A method of unlocking a vehicle, comprising:
acquiring images of a person approaching the vehicle;
determining a gait and facial features of the person based on the acquired images;
matching the determined gait to a stored gait in a first data set with a first probability exceeding a predetermined value;
matching the determined facial features to stored facial features in a second data set with a second probability; and
unlocking the vehicle if the first and second probabilities collectively indicate the person is an authorized person.

15. The method recited in claim 14, wherein the vehicle is unlocked when an average of the first and second probabilities exceeds a threshold value.

16. The method recited in claim 14, wherein the vehicle is unlocked the second probability exceeds a second predetermined value.

17. The method recited in claim 14, wherein the gait of the person is determined when the person reaches a first predetermined distance from the vehicle.

18. The method recited in claim 17, wherein the facial features of the person are determined when the person reaches a second predetermined distance from the vehicle closer than the first predetermined distance.

19. The method recited in claim 14 further comprising sensing motion of the person from a motion sensor connected to the vehicle, wherein the step of determining a gait of the person includes evaluating the images and the sensed motion.

20. A method of unlocking a vehicle, comprising:
acquiring images of a person approaching the vehicle;
sensing motion of the person;
determining a gait of the person based on the acquired images and sensed motion when the person reaches a first predetermined distance from the vehicle;
determining facial features of the person based on the acquired images when the person reaches a second predetermined distance from the vehicle closer than the first predetermined distance;
matching the determined gait to a stored gait in a first data set with a first probability;
matching the determined facial features to stored facial features in a second data set with a second probability; and
unlocking the vehicle if the first and second probabilities collectively indicate the person is an authorized person.
